(19) United States
(12) Patent Application Publication
(10) Pub. No.: US 2014/0334124 A1
(43) Pub. Date: Nov. 13, 2014

(54) CAMERA FLASH GUN DIFFUSER

(71) Applicant: Tony Ting Mo Chau, London (GB)

(72) Inventor: Tony Ting Mo Chau, London (GB)

(21) Appl. No.: 14/361,691

(22) PCT Filed: Nov. 30, 2012
(86) PCT No.: PCT/GB2012/052963

§ 371 Date: May 29, 2014

(30) Foreign Application Priority Data
Dec. 2, 2011 (GB) 1120738.8

(51) Int. Cl. G03B 15/06; G03B 15/03; G02B 5/02

(52) U.S. Cl. CPC G03B 15/06; G02B 5/0294; G03B 15/03
USPC 362/16

(57) ABSTRACT

A camera flash gun diffuser fits over a camera flash gun. A light input opening over the camera flash gun is angled with respect to a light output window of the diffuser. The inner surface of the casing is reflective so that light is redirected from the flash gun output to the output window. A wall of the casing opposite the flash gun output face comprises an adjustment window that can be opened and closed. This allows direct flash light to escape, for example to provide a controlled amount of upwardly directed general background illumination.

### FIELD OF THE INVENTION

This invention relates to camera flash gun diffusers.

### BACKGROUND OF THE INVENTION

A camera flash gun gives out a bright short burst of light from a relatively small area. Generally, the flash gun is pointed forwards at the subject, and the flash gun is not intended to illuminate the whole field of view. The bright output is often uncomfortable on the eyes for the subject being photographed, and the narrow directional range gives rise to sharp shadowing in the image.

It is well known to alleviate these problems by using a diffuser. For example, some camera flash guns have a pull out diffuse reflector. The camera flash gun is pointed upwardly, and part of the light is reflected towards the subject by the diffuse reflector. This reduces the intensity perceived by the subject, and it also enables additional light to flood the scene, for example by reflection from the ceiling in a room. This reduces the harshness of shadows.

There are also many add-on diffuser products. These generally have one of the following designs:

designs which aim to make the forward directed light more diffuse by applying a diffuser between a forward-facing flash gun and the subject. The diffuser can be at the end of an expanding funnel, to make the output area larger;

designs which aim to increase the area of reflected diffused light, by strapping a large reflector above an upward-pointing flash gun; and

designs which aim to increase the light around the subject to reduce shadows, by providing a diffuser over an upward-pointing flash gun which sends diffusing light in all directions.

There are different problems associated with the different designs.

If light is scattered in all directions to reduce shadowing, a longer flash duration is needed (which is controlled by a feedback system) to achieve the desired exposure of the subject. This drains battery power and results in a longer flash gun recharge period.

If light is directed only forwards, the problem of shadowing is not addressed.

There is also a problem that a different flash configuration is needed for different surroundings, and applying and removing known diffusers takes time which may result in a photo opportunity being lost. The photographer may want diffused forward lighting for one photograph, and a greater amount of surrounding reflected light from other directions in another photograph. Existing diffuser designs do not give this flexibility.

### SUMMARY OF THE INVENTION

According to the invention, there is provided a camera flash gun diffuser, comprising:

an enclosure for mounting over a camera flash gun output face, having a casing, a light input opening for positioning over the camera flash gun output face and a transmissive diffusive light output window which is angled with respect to the light input opening by between 40 and 90 degrees,

wherein the inner surface of the casing is reflective, and wherein a wall of the casing opposite the light input opening comprises an adjustment window that can be opened and closed.

The light output window is angled to the flash gun output, so that the flash is not forward directed to provide a forward directed flash. The light is scattered within the enclosure before exiting the window. The light input opening and the output face can be perpendicular. This means that the flash gun is upward pointing for a forward flash, and it means the adjustment window is also facing upwardly. By opening the adjustment window, some light is allowed to escape to provide surrounding illumination. In this way, surrounding illumination to reduce shadows is only provided when needed. In this way, power consumption can be kept to the minimum for the effect desired.

For normal flash gun operation, the diffuser can be taken off. However, the flash gun can instead be pointed forwardly and the adjustment window opened. This means the diffuser effect can effectively be turned off by simply opening the window, which is less time consuming than removing the diffuser.

The adjustment window can be opened fully, so that light escapes upwardly for reflection from a ceiling, or it can be partially opened.

The adjustment window can be hinged to the remainder of the enclosure for this purpose. A fixing is preferably provided for fixing the adjustment window into a selected one of a plurality of positions. This can for example be a ratchet mechanism or a high friction hinge.

The adjustment window is preferably hinged at the back with respect to the light output window such that it reflects light in the direction of the light output window when open. In this way, the amount by which the adjustment window is opened determines how much light is transmitted upwardly to the ceiling and how much is reflected forwards by the adjustment window.

A retaining structure can be provided for supporting a light filter over the camera flash gun output face. Different light filters can be used for different conditions, to enable the flash gun output colour point to be controlled. A slot can for example be provided for removably receiving a light filter. The invention also provides a camera flash system comprising a camera flash gun for mounting on a camera hotshoe and a diffuser of the invention mounted over the light output face of the camera flash gun.

The camera flash gun preferably comprises a base part for mounting on the camera hotshoe and a top part having the flash gun output face, wherein the top part is rotatable about a vertical axis with respect to the normal landscape camera orientation and about a horizontal axis with respect to the normal camera orientation, wherein the horizontal axis rotates with rotation of the top part. The light output window preferably faces a direction parallel with the horizontal axis. This means that the adjustment window can be made to face upwardly for both portrait and landscape orientations of the camera.

The invention also provides a camera comprising a camera body and a camera flash system of the invention.

### BRIEF DESCRIPTION OF THE DRAWINGS

An example of the invention will now be described in detail with reference to the accompanying drawings, in which:

FIG. 1 shows a known camera with the flash gun facing upwards and shows the adjustments that can be made;

FIG. 2 shows a known camera with the flash gun facing forwards;

FIG. 3 shows a known camera with the flash gun facing upwards and a retractable reflector extended;

FIGS. 4 to 7 show different views of a camera flash gun diffuser of the invention;

FIGS. 8 to 11 show different ways of using the flash gun diffuser of the invention when mounted on a camera.

### DETAILED DESCRIPTION

The invention provides a camera flash gun diffuser which fits over a camera flash gun. A light input opening over the camera flash gun is angled with respect to a light output window of the diffuser by for example 90 degrees. The inner surface of the casing is reflective so that light is redirected from the flash gun output to the output window. A wall of the casing opposite the flash gun output face comprises an adjustment window that can be opened and closed. This allows direct flash light to escape, for example to provide a controlled amount of upwardly directed general background illumination in addition to the diffused forward directed subject illumination.

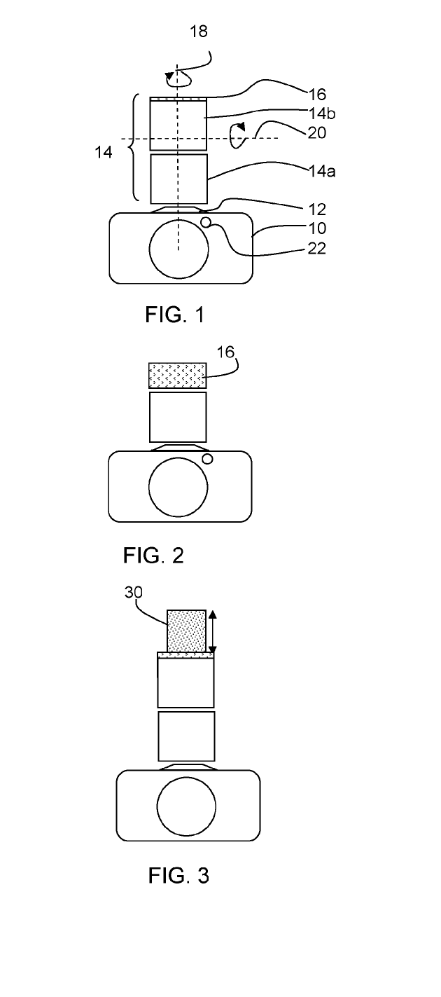

FIG. 1 shows a known camera with the flash gun facing upwards and shows the adjustments that can be made.

The camera comprises a camera body 10 with a hotshoe 12 and a flash gun 14. Professional camera flash guns are typically adjustable in the manner shown. The flash gun has a base part 14a for mounting on the hotshoe 12 and a top part 14b having the flash gun output face 16. The top part is rotatable about a vertical axis 18 with respect to the normal camera orientation and about a horizontal axis 20 with respect to the normal camera orientation. The horizontal axis rotates 20 with rotation of the top part 14b. This means the flash gun output face can be tilted between upward and forward directions as well as rotated.

The camera has a light sensor 22 for controlling the flash in a feedback manner, to provide the correct exposure of the subject. This can instead be implemented through the lens (TTL).

FIG. 2 shows the camera with the flash gun facing forwards.

The bright light from a small area 16 can be disturbing to a subject, and the light does not fill the field of view, causing shadowing and vignetting.

As shown in FIG. 3, it is known in some flash guns to direct the flash gun upwardly and use a small retractable reflector 30 to provide forward illumination to the subject, but have much of the light directed to the ceiling of a room for example, to provide more general illumination by reflection. The reflector provides more gentle light and is thus more comfortable for the subject. However, much less light reaches the subject so that more battery power is used (because the feedback system controls the flash gun to deliver a longer burst of light) and the flash gun takes longer to recharge.

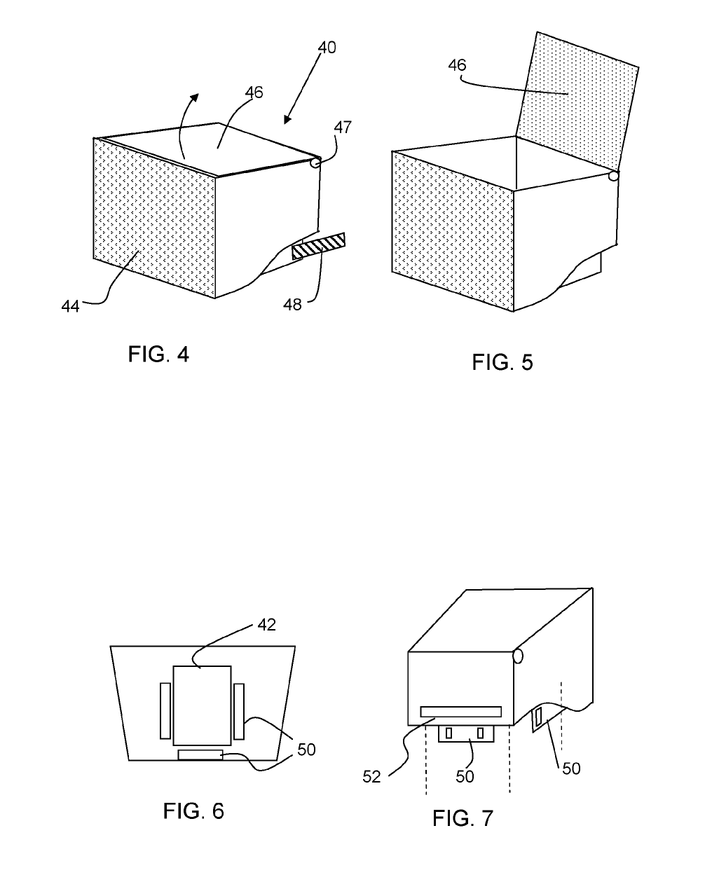

FIGS. 4 to 7 show different views of a camera flash gun diffuser of the invention.

The flash gun diffuser comprises an enclosure 40 for mounting over the camera flash gun output face 16, having a casing, a light input opening 42 for positioning over the camera flash gun output face 16 and a transmissive diffusive light output window 44 which is angled with respect to the light input opening 42. In the example shown, the window 44 is perpendicular to the opening 42, but this is not essential. The angle means that the flash gun light is redirected before reaching the window 44, in particular by a reflective inner surface of the enclosure 40. The angle can be between 40 and 90 degrees, more preferably between 70 and 90 degrees.

A wall 46 of the casing opposite the light input opening comprises an adjustment window that can be opened and closed.

FIG. 4 shows a front perspective view with the adjustment window closed and FIG. 5 shows a front perspective view with the adjustment window open.

The adjustment window 46 is hinged at the back, and this hinge 47 allows the window to be held in a desired position, for example either by a ratchet type mechanism or simply by friction.

The diffuser can be fixed to the camera flash gun, and a strap 48 is shown in simplified form in FIG. 4. The strap enables adjustment to different sizes of flash. Other options are possible, for example a system with a dial used to implement tightening. A dial can be placed at the rear underneath the filter slot opening. The device can then be provided as one universal size with an opening size fitting most flash guns on the market.

FIG. 6 shows a base view to show the opening 42. Tabs 50 are provided around the opening which retain the strap 48 for clamping to the camera flash gun.

The use of a strap and flexible tabs means the diffuser can be used with a range of flash guns. However, it may instead be designed (and supplied with) a specific flash gun in which case a more rigid connection interface can be designed into both products.

The base wall of the enclosure can be removable so that different size and shape openings 42 can be interchanged. Thus, the diffuser may be configurable to match a specific flash gun. Alternatively, adapter rings can be provided for this purpose designed for different flash guns for interfacing with a single diffuser design. The adapter ring is then fixed to the flash gun, and the flash diffuser can then be a simple push fit to the flash gun, with no straps or dials to manipulate.

FIG. 7 show a rear view. This view shows a slot 52 which is part of a retaining structure for supporting a light filter over the camera flash gun output face 16. Different light filter sheets, for example made of perspex, can be placed in the slot, and for example held by internal runners (not shown). These can be used by the photographer to set a desired flash colour point for a particular lighting effect which is desired. The diffuser can be supplied with a set of light filters.

The diffuser of the invention allows many different configurations, and with easy and quick adjustment between these configurations.

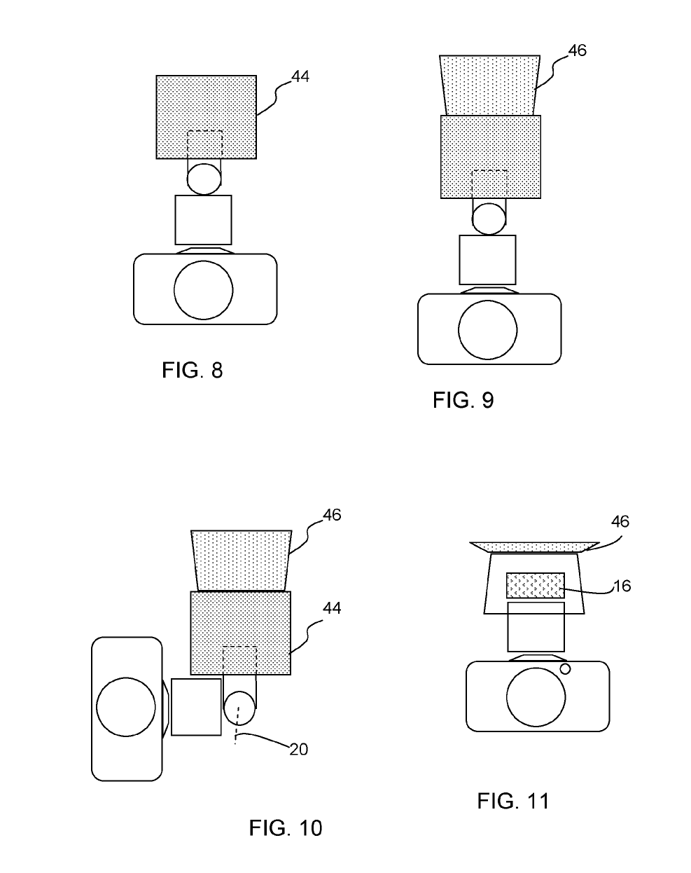

FIGS. 8 to 11 show different ways of using the flash gun diffuser of the invention when mounted on a camera.

FIG. 8 shows the camera with the flash gun pointing up, and the diffuser presenting a forward facing diffused light output. The adjustment window 46 is closed. Virtually all light is directed forwardly so that battery power is preserved, but a more diffuse light output is provided.

FIG. 9 shows the camera with the flash gun pointing up, and the diffuser presenting a forward facing diffused light output. The adjustment window 46 is open. A controllable amount of light escapes upwardly to provide more general illumination. By selecting the angle of the window 46, the desired compromise between shadow reduction (best when the window is fully open) and power saving (best when the window is closed) can selected. The adjustment window 46 has a diffuse reflective surface so that it reflects diffuse light towards the subject, by an amount dependent on the angle of the window 46.

There is a direct light path from the flash gun output face to the open adjustment window, whereas the path to the diffuser output face is mainly indirect with reflection from the internal surface of the enclosure.

The light output window 44 faces a direction parallel with the horizontal axis 20. As shown in FIG. 10, this means that the window 46 can face upwardly even when the camera is in portrait orientation.

FIG. 11 shows that a non-diffused camera flash gun output can be provided by making the flash gun forward facing and fully opening the window 46. Thus, the diffuser can be disabled more quickly than removing it, simply by opening the window 46.

The diffuser can be collapsible for easy storage or rigid. A collapsible version can comprise a set of walls which click together. A rigid version can comprise a plastic housing. In all cases, light should be contained within the enclosure other than for escape through the output face 44 or opened adjustment window 46.

The way the diffuser mounts over the camera flash gun can be routine, and indeed there are many available diffuser products for fitting to non-specific flash guns.

The inside surface of the enclosure is specular reflective or diffuse reflective. The adjustment window is however diffuse reflective on its inner surface. Diffuse reflective surfaces can simply comprise a matt white surface.

The transmissive diffusive output face 44 can be removable, so that two degrees of diffusion can be achieved—one based on the internal walls of the enclosure and the other based on the combination of this with the output face 44.

The device can be made with various dimensions. A larger dimension output face will give better diffusion but make a more cumbersome product. Thus, a compromise can be found. For example the light output face can be approximately square, with side length between 7 cm and 12 cm. The depth of the diffuser enclosure can for example be between 7 cm and 20 cm, preferably 10 cm to 15 cm.

The invention enables many different configurations with a single device. The reconfiguration is extremely quick and easy.

With the adjustment window open, surrounding illumination is provided in a power efficient way. For example most light is still directed forwardly, and there is no direct flash light sent backwards. This is a problem with some diffuser designs, not only because power is wasted, but also because subjects behind the photographer can be disturbed by the flashing.

Various other modifications will be apparent to those skilled in the art.

1. A camera flash gun diffuser, comprising:
an enclosure for mounting over a camera flash gun output face, having a casing, a light input opening for positioning over the camera flash gun output face and a transmissive diffusive light output window which is angled with respect to the light input opening by between 40 and 90 degrees,
wherein the inner surface of the casing is reflective, and wherein a wall of the casing opposite the light input opening comprises an adjustment window that can be opened and closed.

2. A diffuser as claimed in claim 1, wherein the adjustment window is hinged to the remainder of the enclosure.

3. A diffuser as claimed in claim 2, comprising a fixing for fixing the adjustment window into a selected one of a plurality of positions.

4. A diffuser as claimed in claim 2, wherein the adjustment window is hinged at the back with respect to the light output window such that it reflects light in the direction of the light output window when open.

5. A diffuser as claimed in claim 1 comprising a retaining structure for supporting a light filter over the camera flash gun output face.

6. A diffuser as claimed in claim 5, wherein the retaining structure includes a slot for removably receiving a light filter.

7. A diffuser as claimed in claim 1, wherein the light input opening and the light output window are perpendicular.

8. A camera flash system comprising a camera flash gun for mounting on a camera hotshoe and a diffuser as claimed in claim 1 mounted over the light output face of the camera flash gun.

9. A camera flash system as claimed in claim 8, wherein the camera flash gun comprises a base part for mounting on the hotshoe and a top part having the flash gun output face, wherein the top part is rotatable about a vertical axis with respect to the normal camera orientation and about a horizontal axis with respect to the normal camera orientation, wherein the horizontal axis rotates with rotation of the top part.

10. A camera flash system as claimed in claim 9, wherein the light output window faces a direction parallel with the horizontal axis.

11. A camera comprising a camera body and a camera flash system as claimed in claim 8.
